(19) United States
(12) Patent Application Publication
(10) Pub. No.: US 2023/0019634 A1
(43) Pub. Date: Jan. 19, 2023

(54) SYSTEM AND METHOD FOR TRANSFERRABLE DATA TRANSFORMATIONS

(71) Applicant: Rose Technology Incorporated, Las Vegas, NV (US)

(72) Inventors: Alexander Campbell, Las Vegas, NV (US); Neville Jos, New York, NY (US)

(21) Appl. No.: 17/949,993

(22) Filed: Sep. 21, 2022

Related U.S. Application Data
(63) Continuation-in-part of application No. 16/861,307, filed on Apr. 29, 2020, now abandoned.
(60) Provisional application No. 62/845,493, filed on May 9, 2019.
(60) Provisional application No. 62/840,228, filed on Apr. 29, 2019.

(51) Int. Cl. G06F 16/2455; G06F 16/2453

(52) U.S. Cl. CPC G06F 16/24552; G06F 16/24539

(57) ABSTRACT

This invention enables users to work with large datasets that are available from data producers, transforming the data into meaningful information whose derivation may later be easily comprehended. Users can build queries by applying transformation functions to the datasets. These queries can be saved and used to build further queries, and queries can be saved and visualized, creating a clear and comprehensible record of data transformations. Inferences are applied to datasets and parameters so that transformations are processed with minimal errors. Limited multiprocessing is implemented on each server on which queries are performed, increasing processing speeds. A graph database of relationships between raw data and queries is used to ensure that queries are performed on updated data. These solutions lead to greater processing efficiency even when datasets tend to be enormous and subject to frequent updates.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This application is a continuation-in-part of co-pending patent application Ser. No. 16/861,307, filed Apr. 29, 2020, titled SYSTEM AND METHOD FOR TRANSFERRABLE DATA TRANSFORMATIONS, which claims priority to U.S. Provisional Appl. No. 62/840,228 filed on Apr. 29, 2019, and U.S. Provisional Appl. No. 62/845,493 filed on May 9, 2019, which are incorporated herein by reference.

### FIELD OF THE INVENTION

The invention generally pertains to the field of data processing in a computer system.

### BACKGROUND

Petabytes of data are being generated each day that individuals and corporations are interested in using. The cacophony of data in the world has led to a major problem for consumers of data; the inability to understand how the data was created and whether it can be trusted to be of high quality.

Most producers of data unintentionally obfuscate the process through which they create data. This is because most data work sits in discrete files written in commercial software and programming languages on the producer's computer with only the producer knowing the location of these files and how they link together. Generally, producers of data have little to no documentation on this process and rely on their memory.

This methodology breaks down in a few different situations. A consumer of data may disagree with the output, forcing the producer to rely on their memory of file locations and links to try to figure out if there is a mistake in the data process or if the consumer is wrong. For example, a financial analyst creates an indicator for XYZ stock that says that the company should be buying more XYZ stock. The CIO of the company does not believe that the analyst is right. The process through which their differences reconcile requires the CIO to understand how the analyst made the indicator.

In another example, two producers of similar data have wildly different results. Since each producer has a bespoke methodology for creating data, it is a daunting task to figure out the reason for the difference. For example, two financial analysts create indicators for XYZ stock, one of which says to buy the stock, the other saying to sell. To reconcile their differences, the analysts have to be able to compare their processes side by side without having to manually look through each other's files.

Finally, since every producer has a different methodology for creating and sharing data, the ability to use data from different sources is difficult. For a financial analyst to create an XYZ stock indicator, they have to consume data from three sources, all of whom have bespoke methodologies to interact with.

### SUMMARY

The systems and methods described herein enable users to work with large datasets that are available from data producers. Examples of such datasets include price data, population data, traffic data, weather data, etc. . . . . The systems and methods described herein enable those datasets to be used as building blocks, allowing users to build calculations by applying transformation functions to the datasets. These calculations, or queries, can be saved and used to build further queries, and can be easily visualized so that knowledge can readily be transferred. By enabling savable and viewable queries, a clear record of data transformations can be shared.

The final product of these calculations and queries creates a new data object. Every individual calculation and query also creates a new data object. The new data object can be a derivative data object or simply a cleaned version of the raw dataset.

Data cleaning means identifying incomplete, incorrect, inaccurate or irrelevant parts of the data and then, depending on the context of the data processing, replacing, modifying, or deleting the dirty or coarse data.

The systems and methods described herein include solutions for more efficient processing of raw datasets, in particular through the use of parallel or multiprocessing solutions.

Raw datasets contemplated herein are often massive tables of long term periodic data. Furthermore, the systems and methods described herein include solutions for efficiently updating stored queries when such datasets are updated, which can be a frequent occurrence. In order to reduce processing time, we use a graph database storing relationships between raw datasets and their dependent queries.

The systems and methods described herein contemplate a software product that requires few user decisions. Instead, the systems and methods described herein make inferences for the user in order to perform calculations, rather than creating errors that the user is required to fix. For instance, users do not need to specify a time period when raw data is spotty, or when two raw data tables have mismatched time periods. Rather, the system will calculate the appropriate time period by making inferences about the data.

### BRIEF DESCRIPTION OF THE DRAWINGS

FIG. 1 is a system diagram.

FIG. 2 is a sample user interface.

FIG. 3 is a sample user interface.

FIG. 4 is a flowchart.

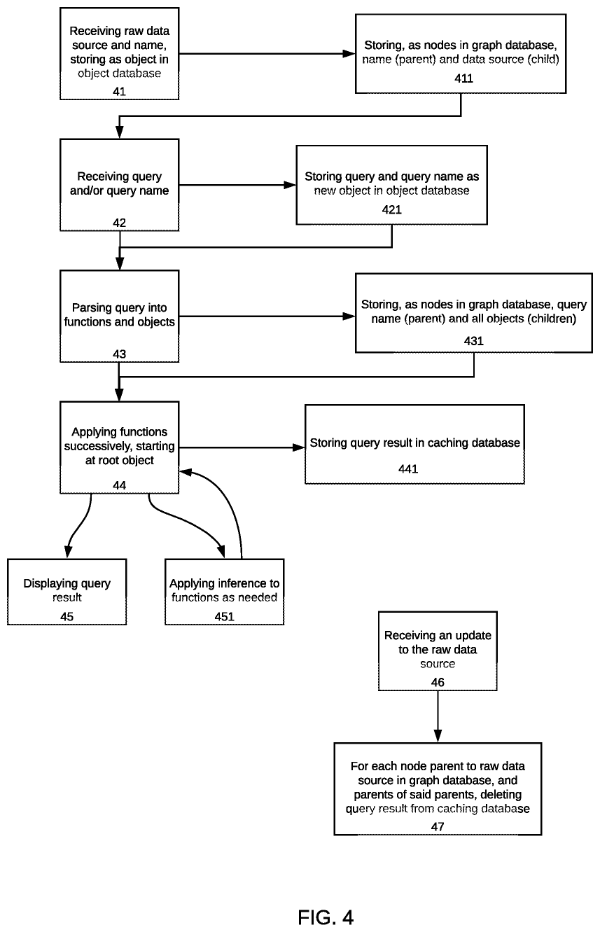

FIG. 5 is a visualization of a graph database.

FIG. 6 is a flowchart of multiprocessing steps.

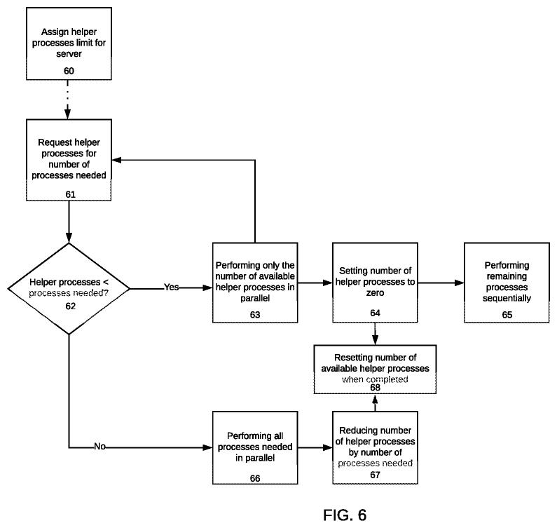

FIG. 7 is a flowchart of system actions enabling users to share an image illustrating the relationship between a raw data object, a final data object, and transformations required to create the final data object.

### DETAILED DESCRIPTION

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. The proper scope of the invention is defined by the claims, and therefore the following detailed description does not limit the invention but serves to give further description to the claims.

The present invention may be a system, a method, and/or a computer program product. The computer program product may comprise a computer readable storage medium (or media) having computer readable program instructions thereon for causing a processor to carry out the processes of the present invention. Computer readable program instructions described herein can be downloaded to respective computing/processing devices from a computer readable storage medium or to an external or remote computer or external or remote storage device via a network, for example, the Internet, a local area network, a wide area network and/or a wireless network. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Ruby, Java, C++ or the like, and conventional procedural programming languages, such as the “C” programming language or similar programming languages.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The computer readable program instructions are executed by one or more platform servers, e.g., [10], [11], which are connected to a network [12], for example, the Internet, a local area network, a wide area network and/or a wireless network, and accessed through an Internet browser [151] or an application or “app” on a user's computing device [15]. As used herein, reference will be made to platform server [10] as representative of any location at which the computer readable program instructions are executed, including platform server [11], user's computing device [15], or any other computing device capable of executing the computer readable instructions.

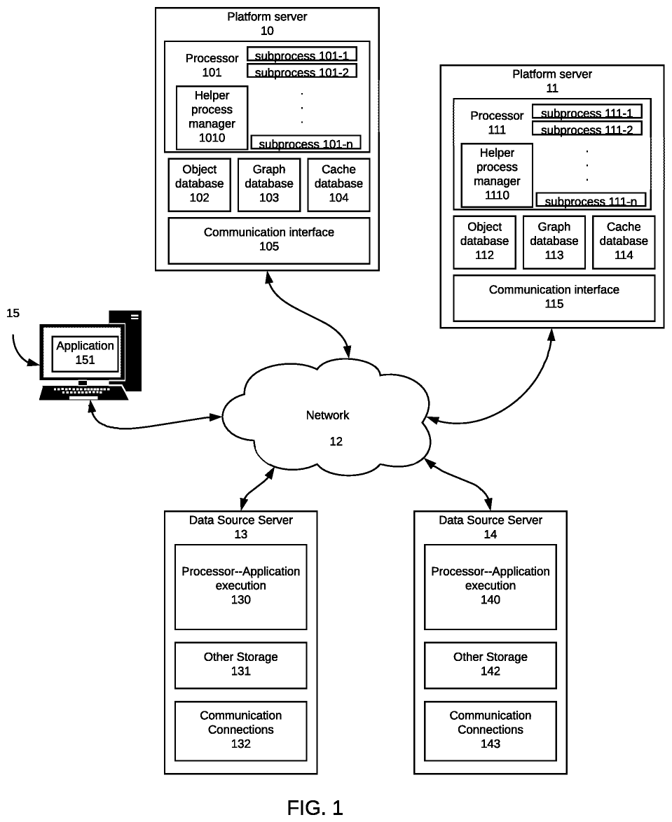

For instance, in the system depicted in FIG. 1, instructions are executed by processor [101] of platform server [10]. The processor [101] can access one or more databases or other storage [102]-[104] in which data pertaining to the systems and methods of the present invention are stored. Depending on the configuration and type of computing device, databases and other storage may comprise, but are not limited to, system memory, volatile (e.g. random access memory (RAM)), non-volatile (e.g. read-only memory (ROM)), flash memory, or any combination. Any suitable combination of hardware, software or firmware may be used to implement the memory storage and processing unit. Memory storage and processing units may be implemented with platform server [10] or any other computing devices in combination making up the platform server, wherein functionality may be brought together over a network in a distributed computing environment to perform the functions described herein.

The systems and methods described herein enable users to work with large datasets that may be available at external data source servers, accessible through network [12], such as data source servers [13] and [14] depicted in FIG. 1. Examples of such datasets include price data, population data, traffic data, weather data, etc. . . . . The systems and methods described herein enable these datasets to be used as building blocks, allowing users to build calculations using the datasets. These calculations, or queries, can be saved and used to build further queries. The systems and methods described herein allow the building blocks of the queries to be easily visualized so that knowledge can easily be transferred.

As used herein, “object” (except to the extent used to refer to “object oriented programming” or “object code” and related computer programming terms that would be understood by those of ordinary skill in the art) refers to anything stored in object database, e.g. [102], [112], or its equivalents, including but not limited to, usernames, raw data in any form, such as a spreadsheet, links to raw data, and queries. Each object in an object database is given a name by the uploader.

“Raw data,” as used herein, can be data in any form and from any source, including but not limited to time series data, tabular data, documents, and images. Raw data is often available from third party servers, such as data source servers [13] and [14], but may also reside in memory on platform server [10].

“Query” or “queries,” as used herein, refers to one or more functions applied to an object. “Functions,” as used herein, are applied to objects and optionally, parameters, resulting in a transformation of said inputs. Examples of functions include data transformation calculations such as add, sort, mean, correlation, search, etc. . . . Functions may optionally be applied to parameters, which may be a wide variety of inputs including objects, integers, floats, and strings. . . . Strings may refer to the name of an object, the name of a column in a table, or some other type of instruction as will be further discussed herein.

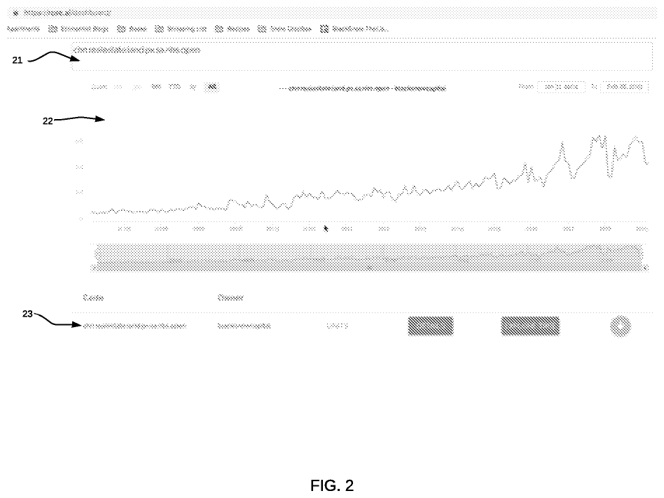

A user accessing the system and methods of the present invention may be provided with a user-interface on application [151] through which the user can enter commands, view transformed data graphically, and view sources, owners and other information regarding the transformed data. For instance, FIG. 2 shows a user-interface with a command window [21], in which a command to show the object named “chn.realestate.land.px.sa.nbs.open” has been entered, a graphical representation window [22] showing a plot of the opened object, and an information window [23] showing sources, owners and other information regarding the opened object. In the example shown in FIG. 2, the object is a time series of China real estate land price data over a 15 year period, which has been plotted accordingly.

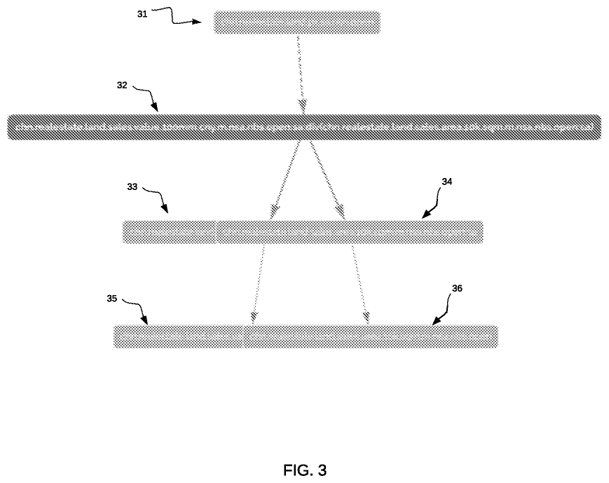

In the simplest use case of the system, the object is a raw data file, but in other cases, as in the example shown in FIG. 2, the object is a query involving one or more functions applied to one or more objects. As shown in FIG. 3, the China real estate land price data [31] object is derived by dividing China real estate sales values [35] by China real estate sales area [36], both of which are datasets available from the Chinese government at, for example, http://www.stats.gov.cn/english. An issue that financial analysts need to deal with is seasonality in datasets. Seasonality is a characteristic of a time series in which the data experiences regular and predictable changes that recur every calendar year. Many economic statistics contain seasonality and therefore to properly conduct an analysis on the state of a certain market, the data needs to be adjusted or cleaned. The system enables the user to remove or reduce the incomplete, incorrect, inaccurate or irrelevant parts of the data. In FIG. 3, these datasets have been adjusted for seasonality and divided by application of functions, in query [32] —“chn.realestate.land.sales.value. 100 mm.cny.m.nsa.nbs.open:sa:div(chn.realestate.land.sales.area.10 k.sqm.m.nsa.nbs.open:sa) These datasets have been adjusted for seasonality and divided by application of functions, in query [32]—.

“chn.realestate.land.sales.value.100 mm.cny.m.nsa.nbs.open:sa:div (chn.realestate.land.sales.area.10 k.sqm.m.nsa.nbs.open:sa).” In other words, in query [32], division function “:div” is applied to objects named “chn.realestate.land.sales.value.100 mm.cny.m.nsa.nbs.open” [35] and “chn.realestate.land.sales.area.10 k.sqm.m.nsa.nbs.open” [36] to which seasonal adjustment function “:sa” [33], [34] has been applied, respectively. The application of this seasonal adjustment function is an example of the process by which a dataset is transformed through a query to create a new, cleaned data object.

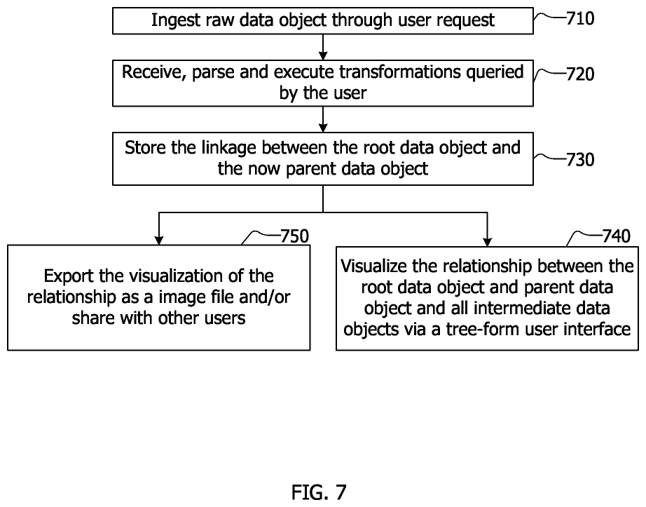

In the process of executing the queries to apply functions [33], [34] on the raw data [35], [36], the system automatically creates and stores the relationship between a query, its component functions, and their raw data objects of application. The entire relationship between a query, its component functions, and their raw data objects of application, can be visualized in a tree-form user-interface, as shown in FIG. 3. In the user-interface shown in FIG. 2, this tree visualization can be accessed by selecting an “Explore Tree” button. Ultimately, the blocks of the “specified logical functions” are available for users to toggle in the web platform via the click of a button. Users can download the tree visualization as an image. The system enables users to share an image to illustrate the relationship between raw data object, the final data object, and the transformations required to create the final data object. This process is shown in FIG. 7

Referring now to FIG. 7, the system ingests the raw data object through a request from the user (710). The system receives, parses and executes transformations queried by the user (720). The system stores the linkage between the root data object and the now parent data object (raw data object+transformations) (730). The system visualizes the relationship between the root data object and parent data object and all intermediate data objects via a tree-form user interface. (740) The system then offers the user the functionality to export the visualization of the relationship as a JPG file or share with other users by email or within the system via the user interface. (750) This process addresses the issue highlighted above where two producers of similar data have wildly different results. By comparing methodology via tree visualizations, producers of data can reconcile how and why their results differ.

For purposes of the examples herein, platform server [10] and databases [102], [103] and [104] will be referred to as the representative server and databases, but the steps of the invention can occur in any platform server that the user can access. Since all functions are performed on objects, and ultimately upon raw data, the system must receive [41] a raw data source and an associated name, which are stored in object database [102] as an object. Queries may be received [42] with an associated query name, causing the query and its associated name to be stored [421] on object server [102] as an object that can be referenced in future queries or other commands, but queries may also be received [42] without an associated query name, i.e. for the purpose of calculating the query without storage. After a query is received [42], it is parsed [43] into its component functions until a root query object is reached. The functions of a query can be nested or chained together, and functions may additionally have parameters as discussed herein. As used herein, “root query object” is the named object on which the innermost nested function is performed.

In the examples discussed herein, functions are denoted by starting with the string “:”, and the object upon which the function acts precedes the “:”, while function parameters are denoted after the function within parentheses “0”, but functions may be denoted in any style. Given this form for the examples discussed herein, parsing occurs backwards and the root query object is found at the front of the query, but parsing may occur in either direction as functions can be programmed in any style.

### Example 1

“northamerica.population=usa.population:add(mex.population):add(can.population)” is parsed into “usa.population”, “add(mex.population)”, and “add(can.population)”. In other words, to “usa.population” named object, which is the root query object, the “mex.population” named object is added, and to the result the “can.population” named object is added. The query is stored [421] as an object in object database [102] with associated name “northamerica.population.” Starting at the root query object, each function is applied [44] successively. The query result can then be displayed [45] graphically.

Functions are applied to their objects flexibly, including by making inferences about raw data and/or parameters when they are not necessarily uniform, instead of reporting errors when exact input requirements are not met. In other words, very little is required of the user in forming queries. Thus, if a function calls for an inference, an inference is applied [451] without further user inputs.

A first type of inference that can be applied is a frequency detection inference. Time-based raw data may contain irregular intervals, rather than regular intervals such as daily, weekly or monthly. When a function involves an interval that isn't necessarily uniform throughout the data, the frequency detection inference is applied [451]. For example, “:dod” or day-over-day, is a function for requesting day-over-day percentage changes in a timeseries. However, a user may apply the function to a raw data object with weekly data or with both weekly and daily data. In this case the inference is to transform the timeseries to a uniform frequency, i.e. daily, by using weekly data for each day of the week. As another example of a frequency detection inference, two timeseries objects having different frequencies are added. In this case, the inference is to transform each timeseries object so that the objects have identical frequencies and can therefore be added. This best frequency is determined by taking the smallest frequency over both timeseries objects, and transforming each of the timeseries by creating entries according to the smallest frequency. Each new entry may take the value of the nearest pre-existing entry, or may be determined by any other calculation.

Another type of inference is a parameter inference. Parameters may be a wide variety of inputs including objects, integers, floats, and strings . . . Strings may refer to the name of an object, the name of a column in a table, or some other type of instruction. In one example of use, the “:add” function can operate to add two objects—one before the “:” and one passed as a parameter, as in “usa.population:add(mex.population).” However, functions may take a variety of parameters without causing errors. A user may build the query “usa.population:add(2)” where the parameter is an int rather than another data source. In this case, the inference is to add 2 to each entry in “usa.population.” In another example, a user may build the query “northamerica. countries.table:add(rosecode)”, where “northamerica.countries.table” is a table as follows:

TABLE 1

| country | rosecode |
|---|---|
| USA | usa.population |
| MEX | mex.population |
| CAN | can.population |

Therefore, the parameter “rosecode” of the query “northamerica. countries.table:add(rosecode)” will be inferred [451] to mean the column of that name, and the “:add” function is applied to each entry in the column.

It is an objective of the invention to present up-to-date information whenever a user performs a new calculation. Raw data sources may be updated frequently, and users may store an unlimited number of queries that depend on previously stored queries, so it is not feasible to regularly check for updates followed by recalculating all queries that depend on any updates. Rather, cache database [104] is used to store new calculations, which are deleted from cache database [104] whenever raw data is updated, and graph database [103] is used to store relationships between queries and raw data, said queries and raw data represented by nodes in the graph database. This information results in minimizing calculation time, which can be significant due to the large size of raw data files, while ensuring up to date information anytime a calculation is performed on updated data.

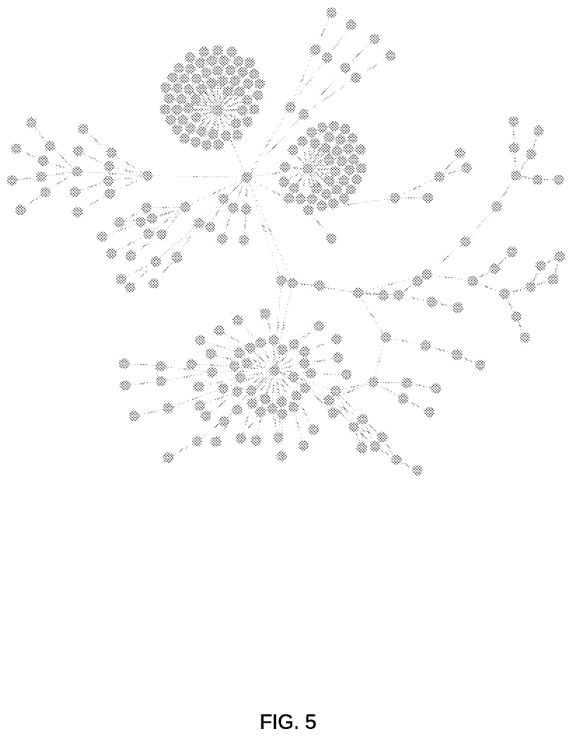

When a raw data source and associated name are received [41], the name and the raw data source are stored [411] as connected nodes in graph database [103], with name as parent to the raw data source. When a query is received [42] with an associated query name for storage and the query parsed [43] into its functions and root query object, the query name and names of all objects in the query are stored [431] as nodes in graph database [103] with the query name as parent to each of the query's objects. Because each user can store an unlimited number of objects and queries, and queries of queries, the graph database can grow to be quite complex, as in the example depicted in FIG. 5.

After the functions of a query have been applied [44], the result of the query is stored [441] in cache database [104]. Thus, the next time someone requests the same query, the calculation does not need to be re-performed. When an update to the raw data source is received [46], however, cache database [104] will hold outdated calculated data. Therefore, for each node in graph database [103] that is parent to the raw data source and any parent of that parent node, and so on, the associated query result in caching database is deleted [47]. The next time someone runs a query that accesses the raw data source, the calculations must be performed from scratch, and the result will be accurate.

Due to the potentially enormous sizes of raw data objects, to which any number of functions can be applied, query calculations can take enormous amounts of processing power and time. To speed up query calculations, a limited amount of parallel processing is enabled on each server [10], [11], etc. . . . as follows: Each server, (e.g. servers [10], [11]), is assigned [60] a helper process limit and an associated helper process manager [1010] that keeps track of a number of available helper processes, which is initially equal to the helper process limit. The helper process limit may be assigned according to known processing power of the particular server. When a query is calculated, the step of applying [44] the functions comprises the additional steps of requesting [61] helper processes for the number of processes needed to be performed. “Processes needed to be performed” include any of the steps needed to apply functions, such as fetching and performing calculations on raw data objects. For instance, a function to add ten different time series will require ten processes to access the ten time series raw data files, plus additional processes to add the data.

The helper process manager [1010] determines [62] the current number of available helper processes for the server and, depending on that number, performs [63] or [66] the appropriate number of helper processes in parallel, and performs [65] the remaining processes needed to be run sequentially. The number of helper processes is reduced [67] by the number of processes needed, unless there are less helper processes than processes needed, in which case the number of helper processes is reduced [64] to zero. Thus, if there are only three helper processes available to retrieve ten time series raw data files, then three helper processes are used to perform [63] the retrieve in parallel, while the remaining seven retrievals are performed [65] sequentially by the main processor. When all helper processes complete, helper process manager [1010] adds [68] the number of helper processes just used back to the number of helper processes. More helper processes are requested [61] if there are still remaining processes that need to be run.

The multiprocessing subprocess described above reduces the calculation time for potentially complex queries, as well as queries that require accessing numerous raw data files. For instance, when a query is complex and parsing of the query yields that dozens of raw data files will be needed, those fetching operations can be undertaken in parallel while calculations can be started sequentially, resulting in reduced processing time. Multiple users may be logged onto a single server, and the helper process manager ensures that multiprocessing is limited and doesn't overwhelm the server.

It is claimed:

1. A computer implemented method for transforming raw data on a server, comprising:
receiving a name and a raw data source;
storing, in a graph database, the name being parent of the data source;
receiving a query comprised of a list of functions, wherein each function in the list of functions is applied to a function object;
parsing the query into each function of the list of functions until a root function object is reached;
executing the functions in the list of functions to transform the function object including cleaning or calculations;
storing, in the graph database, the query being parent of each function object in the query;
starting with the root function object, applying each function to its function object successively to result in a query calculation; and
storing the query calculation in a cache database.

2. The method of claim 1 further comprising:
receiving an update to the raw data source; and
for each graph database entry that is parent to the raw data source, deleting the query calculation from the cache database.

3. The method of claim 1 further comprising:
setting a helper processes limit for the server, wherein a number of available helper processes is initially equal to the helper processes limit;
requesting a number of processes needed to be performed; and
when the number of available helper processes is less than the number of processes needed to be performed:
performing only the number of available helper processes in parallel;
reducing the number of available helper processes to zero; and
performing remaining processes needed sequentially;
when the number of available helper processes is greater than or equal to the number of processes needed:
performing all processes needed to be performed in parallel; and
reducing the number of available helper processes by the number of processes needed.

4. The method of claim 2 further comprising:
setting a helper processes limit for the server, wherein a number of available helper processes is initially equal to the helper processes limit;
requesting a number of processes needed to be performed; and
when the number of available helper processes is less than the number of processes needed to be performed:
performing only the number of available helper processes in parallel;
reducing the number of available helper processes to zero; and
performing remaining processes needed sequentially;
when the number of available helper processes is greater than or equal to the number of processes needed:
performing all processes needed to be performed in parallel; and
reducing the number of available helper processes by the number of processes needed.

5. The method of claim 2 wherein at least one function requires a frequency interval in its function object, and further comprising:
determining a best frequency for the time series; and
transforming the time series according to the best frequency.

6. The method of claim 3 wherein at least one function requires a frequency interval in its function object, and further comprising:
determining a best frequency for the time series; and
transforming the time series according to the best frequency.

7. The method of claim 4 wherein at least one function requires a frequency interval in its function object, and further comprising:
determining a best frequency for the time series; and
transforming the time series according to the best frequency.

8. The method of claim 2 wherein at least one function is additionally applied to a parameter, and a parameter-type inference is made to apply the function to the parameter.

9. The method of claim 3 wherein at least one function is additionally applied to a parameter, and a parameter-type inference is made to apply the function to the parameter.

10. The method of claim 4 wherein at least one function is additionally applied to a parameter, and a parameter-type inference is made to apply the function to the parameter.

11. The method of claim 1 further comprising providing a visualization of the relationship between the root data object and parent data object and all intermediate data objects via a tree-form user interface.

12. The method of claim 11 further comprising providing the user the ability to export the visualization as a graphic file.

13. The method of claim 11 further comprising providing the user the ability to share the visualization with other users.
